(19) United States
(12) Patent Application Publication
(10) Pub. No.: US 2005/0232220 A1
(43) Pub. Date: Oct. 20, 2005

(54) Transmitting packet-based communication information

(76) Inventor: Gregory R. Evans, Frisco, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/825,390

(22) Filed: Apr. 15, 2004

(51) Int. Cl. H04J 3/24

(52) U.S. Cl. 370/349

(57) ABSTRACT

Methods, systems, and devices are provided for transmitting information generated from a packet-based communications device. One exemplary method includes receiving information transmitted from a packet-based communications device and converting the information into a digital audio file. The method also includes selecting multiple destinations connected to the packet-based communications device by different mediums and transmitting the digital audio file to the selected destinations.

### INTRODUCTION

Wireless communications networks are constantly evolving in areas such as: the formats of signal transmission, the kinds of communications, and the number of services they provide. For example, wireless networks have added the capability to transmit packet-based data for mobile wireless communications purposes. In this way, the convergence and interoperation between back-end computing systems (such as servers and data stores) and front-end user devices (such as PDAs and mobile wireless telephones) have been enabled. Such interoperation, for example, allow front-end user devices to access digitized voicemail, order processing, and Internet portals, to name the functions of a few types of back-end computing systems.

Global System for Mobile (GSM) communications network providers, among others, have been implementing a packet-based communications format called General Packet Radio Service (GPRS). Similarly, Code Division Multiple Access (CDMA) networks can use a technology called One Times Radio Transmission Technology (1×RTT) to provide packet-based communication. Through use of such packet-based communications, wireless networks, for example, can support the use of mobile computing applications on mobile handsets which use the transmission of packet data in order to communicate with traditional back-end computing components.

For instance, one such application is the connectivity of wireless PDAs and mobile wireless telephones to an e-mail server. By enhancing the data rates supported by these networks by providing packet-based services, the usable lifetimes of existing network infrastructures such as 2G, 2+G, 2.5G, and 3G infrastructure types (e.g., Time Division Multiple Access (TDMA), GSM, and Code Division Multiple Access (CDMA)) can be extended.

GPRS and 1×RTT are essentially overlays on top of existing networks, such as GSM and CDMA. The GPRS and 1×RTT formats allow networks to reuse frequencies across multiple users and, thereby, increase the use of the available transmission frequency spectrums. In order to update a GSM or CDMA network, a couple of network components and a software upgrade can typically be added to the network infrastructure to implement the overlay.

Packet-based communications formats can also be utilized on 2+G, 2.5G, and 3G networks, such as Wideband-CDMA (W-CDMA), Universal Mobile Telecommunication System (UMTS), and Enhanced Data for Global Evolution (EDGE) networks, and the like, in addition to the above mentioned 2G networks. For example, an EDGE network is a network between 2G and 3G that enhances an existing GSM and GPRS implementation, thereby providing users with increased data rates. The EDGE network reuses the existing GSM/GPRS network components and cell plans but increases the data rates by increasing the data capacity of a GSM time slot by aggregating time slots together.

One form of packet-based communication is called Push to Talk (PTT), or Push to talk over Cellular (PoC). PTT is a packet-based format that enables compatible mobile phones to function like two-way radios or ‘walkie-talkies’ in a 1-to-1 or 1-to-many group mode. In this method of communication, one user talks (e.g., holds the floor), while the one or more other users in the group that are part of the PTT session listen. Upon release of the floor, another user can take the floor and speak, again, while the others in the group listen to the response. PTT systems can be used with half-duplex phones and, therefore, the hardware costs to the end user can be less than full-duplex hardware.

Additionally, application programs have been developed to attach voice mail messages to an e-mail message, thereby enabling voice mail messages to be sent via the Internet to an e-mail address where they can be played at a later time. In order to attach a voice mail message to an e-mail message, various audio file formats can be used to compress the voice message for storage and/or for faster transmission. For example, audio files can be formatted in short stand-alone segments, such as in the WAV, MPG, BWF, or MP3 file formats, as such are known in the art.

To convert the voice mail message to a compressed format audio file, the voice mail message would have to be retrieved from the voice mail system and an application program could then be used to perform the conversion. Once a compressed audio file is created, the user can then attach the file to an email. A number of selected recipients can then be selected and the file sent to the selected recipients.

### BRIEF DESCRIPTION OF THE DRAWINGS

FIG. 1 is an example of a system environment.

FIG. 2 illustrates a method embodiment of transmitting information.

FIG. 3 illustrates another method embodiment transmitting information.

### DETAILED DESCRIPTION

Embodiments of the present invention provide methods, systems, and devices for transmitting real-time information to various destinations. In this way, real-time information can be communicated to destinations, such as an e-mail address or calendaring program, without having to first be saved as a voice mail message, for example.

The information can also be communicated to several recipients at the same time and/or can be sent in a variety of media formats. In this way, the same voice message can be communicated to one or more destinations in an e-mail, voice mail, and text formats, and to programs such as a calendaring or note taking application at the same time or when such formats are desired.

For example, a user may want to send some notes to their office for review at a later time. By selection of a note taking destination, the notes can be spoken and delivered to the note taking application in a format usable by the application. In another instance, the user may want to send an important message to a variety of destinations used by a particular user in order for the user to receive the message at their earliest use of any of the destinations. In this situation, the number of destinations can be selected when composing the message and the message can be sent to each of the destinations in the appropriate formats for each of the destinations.

In some embodiments, for example, the above can be accomplished by using the convenience and functionality of a Push-To-Talk communication system having advantageous features such as near instantaneous communication, push-button initiation, and digitized voice data. However, the invention is not so limited to these advantages or to such a system.

The information can be transmitted by various transmission mediums and can be transmitted or converted to various media formats. For example, transmission mediums can include wired or wireless communications systems and media formats can include text, audio, and other suitable media formats, to name a few. Embodiments provide devices and systems having processors, and memory connected to the processor, that includes destination information for a number of destinations stored thereon.

For example, destinations can include e-mail, a remote receiver, such as a wireless telephone or PDA, an application program, such as a calendaring, note taking, or messaging program, to name a few. For instance, a transceiver or transmitter component can be used for transmitting and/or receiving the destination and voice data from a push to talk session with a network device over a network to a note taking program resident on a component of the network.

A file format can be selected for a destination selected from the number of destinations (e.g., such as destinations stored in memory). This can be achieved through program instructions which execute to select a file format from a list of file formats. The destinations stored in memory can include a list of available medium types and the select of the file format can be based upon the selection of a medium type. In various embodiments, a file format can be associated with a destination. In this way, when a destination is selected, the file format can be automatically selected.

Embodiments of the present invention can be used with various types of networks, including, but not limited to a GSM network, a network that includes General Packet Radio Services (GPRS), a CDMA or W-CDMA network, a TDMA network, an EDGE network, and a UMTS network, to name a few.

Additionally, as indicated above, in various embodiments, real-time information can be converted into a digital audio file format. For example, program instructions can be provided which execute to convert the received information from the push to talk session into a WAV or MP3 type digital audio file, to name a few.

In various embodiments, a packet-based communications system includes a packet-based communications enabled device, such as a personal computer (PC), handheld device (e.g., wireless telephone, personal digital assistant (PDA), etc.) laptop computer, and the like. These devices can include destination information for a number of destinations provided thereon and a selection interface for selecting a destination from the number of destinations.

System embodiments also include a network device for receiving the destination information and voice data from the enabled device. The network device can include a processor, memory connected to the processor and program instructions stored in memory and executable on the processor. The program instructions can execute to convert the received voice data from the push to talk session into a digital audio file. Program instructions can also be provided to transmit the digital audio file to the selected destination.

Program instructions on the network device can also be provided to execute to identify selected destinations based upon a rich header provided with the voice data from the packet-based communications enabled device, or through header information “encoded” within a destination list, or through a translation of header information from a destination list which points to a particular type of program instead of to a traditional contact entity, such as a person, etc. A rich header can be inserted at the beginning of a transmission carrying the data file to provide a variety of information about the data being transmitted. For example, information in the header can be used to select an appropriate “player” application for the type of data (e.g., image, video, voice, etc.) the header indicates.

The system can also include a base station or radio network controller for receiving the destination information and voice data from the enabled device. The network device can be a network server and can be a server that provides and/or manages Push to Talk functionality on the system.

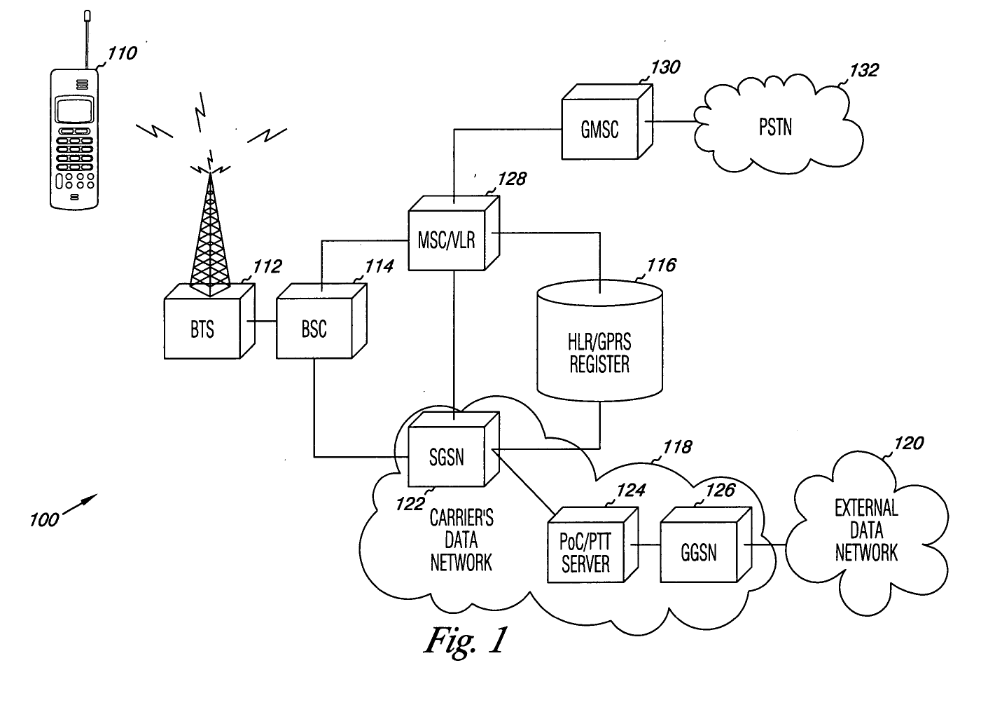

FIG. 1 illustrates an example of a system environment for use with embodiments of the present invention. This system is provided for illustrative purposes and therefore, the embodiments of the invention should not be limited to use of such system structures.

FIG. 1 provides one example of a system environment 100. The system 100 includes a packet-based communications device 110. The communications device 110 communicates information to and from a base station that provides connection to a voice and a data network, however, the invention is not so limited. In the embodiment shown in FIG. 1, the base station includes a Base Transceiver Station (BTS) 112 and a Base Station Controller (BSC) 114.

The BTS 112 is provided to send and receive voice and data information with a number of packet-based communications devices connected to the voice and data networks, such as communications device 110. The BSC 114 can identify and route the information to other parts of the voice and data networks. For example, as shown in FIG. 1, the BSC 114 is connected a data network structure 118 and a voice network structure.

The data network structure 118 of FIG. 1 includes components such as a Serving GPRS Support Node (SGSN) 122, a PoC/PTT server 124, and Gateway GPRS Support Node (GGSN) 126. As stated above, the SGSN and GGSN components perform the tracking of packet-based mobile terminals, the security and access control to the packet-based network, and interface with external packet data networks for exchange of packet-based data, among other functions.

In the system shown in FIG. 1, the PoC/PTT server 124 provides the software to implement the network's Push to Talk functionality and manage that functionality for the network. The PoC/PTT server 124 can include memory for storing data with regard to the operation of the Push to Talk functionality of the network as well as information from, or information to be directed to, a communications device, such as communications device 110.

For example, voice data from a real-time PTT session on communications device 110 can be received and/or converted by the PoC/PTT server 124. The voice data can also be stored on the PoC/PTT server 124 in memory or passed on to another part of the data network 118 or another network connected thereto. For instance, real-time, stored, or converted voice data can be passed by the PoC/PTT server 124 to an external network 120 through the GGSN 126. Examples of external networks that can be connected to the data network 118 include, but are not limited to, the Internet, Wi-Fi networks, corporate network, and other such networks. In various embodiments, the PoC/PTT server 124 can also pass voice data through the voice network to the Public Switched Telephone Network (PSTN) 132 via the SGSN 122.

The voice network structure includes the Multiple Switching Center (MSC)/Visiting Location Register (VLR) 128 and a Gateway MSC (GMSC) 130. The MSC/VLR 128 provides the functionality of the MSC for communication with the communications device 110 in which this voice network is the communications device's home network. The MSC/VLR 128 also acts as the VLR for communications devices 110 that are visiting the voice network.

The GMSC 130 provides a gateway to and from the PSTN 132. In the system example shown in FIG. 1, the functions of the Home Location Register and the GPRS register are provided by component 116. In this way, the voice and data networks can share some of the components of the system 100.

In order to transmit voice data, a packet-based communications session has to be initiated on the communications device 110. To initiate a session, one or more contacts have to be selected. The selection can be from selection of a contact from a contact list and/or from manual entry of contact information on the communications device.

Contacts can include information such as one or more destinations at which the contact can be reached. For example, destinations can include: a land line telephone, a wireless telephone, an e-mail program application, a calendaring program application, a pager, a multi-media program application, a filing program application, a voice mail system, and a message management program application, among others.

The destinations can include destination information regarding how the communications device is to contact the destination. For example, destination information can include telephone numbers, e-mail address, IP addresses, and other routing information. In various embodiments, the user can select one or more destinations for a single contact if a number of destinations have been associated with the contact.

The voice data from the communications device 110 can be transmitted to each destination in a variety of formats. For example, the voice data can be transmitted directly as voice data or can be converted to a number of different file formats, such as a digital audio file, a word processing file, short messaging service (SMS) data, and/or an html file. The conversion can be performed on the communications device 110 or in one of the components of the system 100 or network connected thereto.

In various embodiments, the choice of format can be included in the destination information, such that when a destination is selected, a format is chosen. For example, when a transmission is to be made to an e-mail address, the destination information can include the selection of an e-mail compatible format.

In some embodiments, the selection of format can be made by the user. This can be advantageous, for example, when a destination can support more than one format, such as an e-mail program can support an html format or a digital audio file attached to an e-mail message. In such situations, the user can select which format should be used.

Once the selection of contacts, destinations, and formats has been made, a connection can be made to the various destinations. In various embodiments, such as those using Push to Talk technology, the system can check to see which contacts and destinations are currently active. The system or the user can then select a number of contacts based upon the information as to whether or not they are active. Contacts and destinations that are currently active include devices and systems that are ready to receive incoming transmissions.

Additionally, in various embodiments, the contacts and/or destinations can be selected based upon a level of urgency. For example, if it is extremely urgent that the user contact a particular person or group of people, all of the destinations available for that person or persons can be selected automatically based upon the designation of the information as urgent.

After the connection has been made, a voice communication session can be initiated, and real-time information can be provided to the communications device. For example, a user can speak into a microphone on a communications device and that spoken information can be transmitted to the selected destinations as real-time data and/or converted into a file format. For instance, the information can be sent to one or more contacts having destinations such as a voice mail box in real-time data, sent to an e-mail address as a digital audio file, and sent to a calendaring program as an html or word processing format file.

In such embodiments, the communications device does not have to store the data on the device, but rather, the information can be stored on a network device such as a server. This allows for a greater amount of information to be maintained by the user since more space may be available on the server than is available on the device and allows the memory on the device to be used for other device functions.

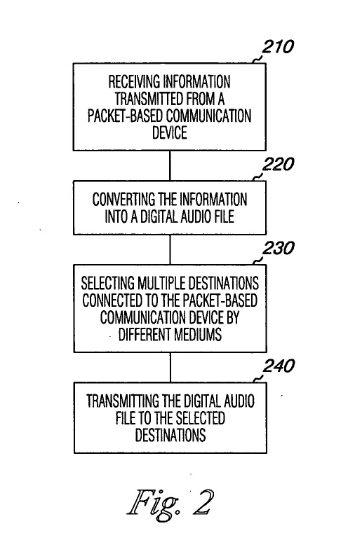

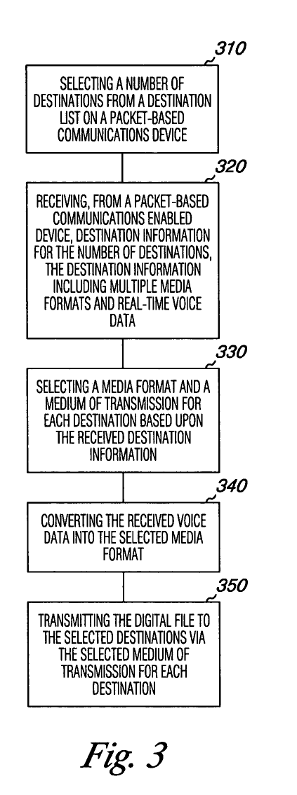

FIGS. 2 and 3 illustrate method embodiments of transmitting information generated from a packet-based communications device. As one of ordinary skill in the art will understand, various embodiments including those illustrated in FIGS. 2 and 3, can be performed by software, application modules, and computer executable instructions operable on the systems and devices shown herein or otherwise.

The invention, however, is not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments, or elements thereof, can occur or be performed at the same point in time.

FIG. 2 illustrates a method embodiment of transmitting information generated from a packet-based communications device. As shown in the embodiment of FIG. 2, the method includes receiving information transmitted from a packet-based communications device as shown in block 210. Receiving information can include receiving real-time voice data generated during a push to talk session. Receiving information can include information transmitted from a half and/or full duplex communication session.

In block 220, the method includes converting the information into a digital audio file. Converting the information can include converting stored voice data. In various embodiments, the method further includes converting a digital audio file to a text file.

As shown in block 230 the method further includes selecting multiple destinations connected to the packet-based communications device by different mediums. Selecting destinations can be based such things as: information received from the packet-based communications device; the selection of a destination from a list of destinations, such as a list on a packet-based communications enabled device; whether the destination is in an active state; or on a defined level of urgency, among other selection criteria. The method embodiment of FIG. 2 also includes transmitting the digital audio file to the selected destinations at block 240.

In various embodiments the method can also include storing voice data in memory on a network server connected to the packet-based communications device. In various embodiments, the method further includes storing the converted message on a network server until each selected destination becomes active.

FIG. 3 illustrates another method embodiment of transmitting information generated from a packet-based communications device. In the embodiment of FIG. 3, the method includes selecting a number of destinations from a destination list on a packet-based communications device as shown in block 310.

The selection of destinations can be made in various ways and the selection of multiple different types of destinations can be made. For example, the selection of a destination can be based upon the selection of a contact from a contact list on a packet-based communications enabled device. In such lists the contact can be linked to multiple destinations.

Additionally, in various embodiments, the method can include selecting a group of contacts from a contact list on a packet-based communications enabled device. In various embodiments, each contact is linked to multiple destinations. The selection of destinations can include selecting destinations such as a land line telephone; a wireless telephone; an e-mail program application; a calendaring program application; a pager; a multi-media program application; a filing program application; a voice mail system; and a message management program application, among others.

In block 320, the method further includes receiving, from a packet-based communications enabled device, destination information the number of destinations. The destination information can include multiple media formats and real-time voice data. The real-time voice data can, for example, be from a PTT communications session.

And, in block 330, the method includes selecting a media format and a medium of transmission for each destination based upon the received destination information. The media can be provided in a number of different media formats. For example, a media format can be a digital audio file; a word processing file; or an html file.

In block 340, the method includes converting the received voice data into the selected media format. The method also includes transmitting the digital file to the selected destinations via the selected medium of transmission for each destination at block 350.

The information can also be transmitted in a variety of different formats. For example, mediums of transmission can include a land line telephone connection; a wireless voice connection; a wireless data connection; and an Internet connection.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method of transmitting information generated from a packet-based communications device, comprising:
receiving information transmitted from a packet-based communications device;
converting the information into a digital audio file;
selecting multiple destinations connected to the packet-based communications device by different mediums; and
transmitting the digital audio file to the selected destinations.

2. The method of claim 1, wherein receiving information includes receiving real-time voice data generated during a push to talk session.

3. The method of claim 1, further including storing the voice data in memory on a network server connected to the packet-based communications device.

4. The method of claim 3, wherein converting the information includes converting the stored voice data.

5. The method of claim 1, further including converting the digital audio file to a text file.

6. The method of claim 1, wherein selecting each destination is based upon information received from the packet-based communications device.

7. A method of transmitting information generated from a packet-based communications device, comprising:
selecting a number of destinations from a destination list on a packet-based communications device;
receiving, from a packet-based communications enabled device, destination information for the number of destinations, the destination information including multiple media formats and real-time voice data;
selecting a media format and a medium of transmission for each destination based upon the received destination information;
converting the received voice data into the selected media format; and
transmitting the digital file to the selected destinations via the selected medium of transmission for each destination.

8. The method of claim 7, wherein selecting a media format includes selecting a media format from the group including:
a digital audio file;
a word processing file; and
an html file.

9. The method of claim 7, wherein selecting mediums of transmission includes selecting mediums from the group including:
a land line telephone connection;
a wireless voice connection;
a wireless data connection; and
an Internet connection.

10. The method of claim 7, wherein selecting multiple destinations includes selecting destinations from the group including:
a land line telephone;
a wireless telephone;
an e-mail program application;
a calendaring program application;
a pager;
a multi-media program application;
a filing program application;
a voice mail system; and
a message management program application.

11. The method of claim 7, wherein selecting each destination is based upon the selection of a contact from a contact list on a packet-based communications enabled device, wherein the contact is linked to multiple destinations.

12. The method of claim 7, further including selecting a group of contacts from a contact list on a packet-based communications enabled device, wherein each contact is linked to multiple destinations.

13. A computer readable medium having program instructions to cause a device to perform a method, comprising:
receiving information transmitted from a packet-based communications device;
converting the information into a digital audio file;
selecting multiple destinations connected to the packet-based communications device by different mediums; and
transmitting the digital audio file to the selected destinations.

14. The medium of claim 13, wherein the method includes selecting each of the multiple destinations based upon the selection of a destination from a list of destinations on a packet-based communications enabled device.

15. The medium of claim 13, wherein the method includes selecting each destination based upon whether the destination is in an active state.

16. The medium of claim 13, wherein the method includes selecting each destination is based on a defined level of urgency.

17. The medium of claim 13, wherein the method further includes storing the converted message on a network server until each selected destination becomes active.

18. The medium of claim 13, wherein the method includes receiving information includes receiving information transmitted from a half duplex communication session.

19. A packet-based communications enabled device, comprising:
a processor;
memory connected to the processor including destination information for a number of destinations stored thereon;
a transceiver for transmitting and receiving the destination and voice data from a push to talk session with a network device over a network; and
means for selecting a file format for each destination selected from the number of destinations.

20. The device of claim 19, wherein the means for selecting the file format includes program instructions which execute to select a file format from a list of file formats.

21. The device of claim 19, wherein each destination stored in memory has a list of available medium types and wherein the means for selecting the file format includes program instructions which execute to select a file format based upon the selection of a medium type.

22. The device of claim 19, wherein each destination stored in memory includes a file format designation and wherein the means for selecting the file format includes program instructions which execute to select a file format based upon the selection of a destination.

23. The device of claim 19, wherein the network is a Global System for Mobile Communications (GSM) network.

24. The device of claim 19, wherein the network includes General Packet Radio Services (GPRS).

25. The device of claim 19, wherein the network is a Code Division Multiple Access (CDMA) network.

26. The device of claim 19, wherein the network is a Universal Mobile Telecommunication System (UMTS).

27. The device of claim 19, wherein the device further includes program instructions which execute to convert the received information from the push to talk session into a WAV type digital audio file.

28. A packet-based communications system, comprising:
a packet-based communications enabled device including:
destination information for a number of destinations provided thereon;
a selection interface for selecting multiple destinations of the number of destinations; and
a transmitter for transmitting destination information for multiple destinations of the number of destinations and for transmitting voice data from a push to talk session; and
a network device for receiving the destination information and voice data from the enabled device including:
a processor;
memory connected to the processor; and
program instructions stored in memory and executable on the processor to:
convert the received voice data from the push to talk session into a digital audio file; and
transmit the digital audio file to the selected destination.

29. The system of claim 28, wherein program instructions on the network device execute to identify the selected multiple destinations based upon a rich header provided with the voice data from the packet-based communications enabled device.

30. The system of claim 28, wherein the system further includes a base station for receiving the destination information and voice data from the enabled device.

31. The system of claim 28, wherein the system further includes a radio network controller for receiving the destination information and voice data from the enabled device.

32. The system of claim 28, wherein the network device includes a network server.

33. The system of claim 32, wherein the network device includes a Push to Talk server.
